(19) United States
(12) Patent Application Publication
(10) Pub. No.: US 2018/0320643 A1
(43) Pub. Date: Nov. 8, 2018

(54) VEHICLE SERVICING EQUIPMENT AND TECHNIQUES

(71) Applicant: Garry Finch, Greystanes (AU)

(72) Inventor: Garry Finch, Greystanes (AU)

(21) Appl. No.: 15/925,126

(22) Filed: Mar. 19, 2018

(30) Foreign Application Priority Data
May 2, 2017 (AU) 2017202904

(51) Int. Cl. F02M 35/02; F02M 35/10; F02M 26/51; F02M 26/36

(52) U.S. Cl. CPC F02M 35/0204; F02M 35/10222; F02M 26/51; F02M 35/10275; F02M 35/10262; F02M 35/10144; F02M 26/36

(57) ABSTRACT

An automotive induction system cleaning module including a connector configured to connect in use to a supply of cleaning solution, an injector in fluid communication with the connector, and a nozzle in fluid communication with the injector, wherein the injector and nozzle are closely connected so as to minimise a fluid flow path between them.

### BACKGROUND

The present invention relates to improvements in vehicle servicing equipment and techniques.

Currently, emissions of nitrogen oxides (NOx), total hydrocarbon (THC), non-methane hydrocarbons (NMHC), carbon monoxide (CO) and particulate matter (PM) are regulated in Europe for most vehicle types, including cars, trucks, locomotives, tractors and similar machinery, barges, but excluding seagoing ships and aeroplanes. For each vehicle type, different standards apply. Compliance is determined by running the engine at a standardised test cycle. Non-compliant vehicles cannot be sold in the EU, but new standards do not apply to vehicles already on the roads. No use of specific technologies is mandated to meet the standards, though available technology is considered when setting the standards. New models introduced must meet current or planned standards, but minor lifecycle model revisions may continue to be offered with pre-compliant engines.

The legal framework in Europe consists in a series of directives, each amendments to the 1970 Directive 70/220/EEC. The following is a summary list of the standards, when they come into force, what they apply to, and which EU directives provide the definition of the standard.
Euro 1 (1993):
   For passenger cars—91/441/EEC.[9]
   Also for passenger cars and light trucks—93/59/EEC.
Euro 2 (1996) for passenger cars—94/12/EC (& 96/69/EC)
   For motorcycle—2002/51/EC (row A)[10]—2006/120/EC
Euro 3 (2000) for any vehicle—98/69/EC[11]
   For motorcycle—2002/51/EC (row B)[10]—2006/120/EC
Euro 4 (2005) for any vehicle—98/69/EC (& 2002/80/EC)
Euro 5 (2009/9) for light passenger and commercial vehicles—715/2007/EC[12]
Euro 6 (2014) for light passenger and commercial vehicles—459/2012/EC[13]

These limits supersede the original directive on emission limits 70/220/EEC.

In the early 2000s, Australia began harmonising Australian Design Rule certification for new motor vehicle emissions with Euro categories. Euro 3 was introduced on 1 Jan. 2006.

The current emission standard in Europe for light passenger vehicles and light commercial vehicles is Euro 6. Euro 6 differs from Euro 5 in that the maximum limit for HC+NOx emissions has dropped from 0.230 g/km to 0.170 g/km. Vehicle manufacturers have responded to this legislative requirement by implementing a range of technical solutions. Most commonly this involves changes to the induction and exhaust systems to facilitate more efficient removal of pollutants.

The European Committee for Standardisation also publishes standards that prescribe the physical properties of automotive diesel fuel that is permitted to be sold in Europe: the EN 590. Changes to EN 590 have largely mirrored the European emission standards so that, where the emission standard has lowered, the particulate content of contaminants in automotive diesel has also lowered. With each of its revisions the EN 590 has been adapted to lower the sulphur content of diesel fuel as follows:

| Emission standard | At latest | Sulphur content | Cetane number |
|---|---|---|---|
| Euro 1 | 1 Jan. 1993 | max. 0.200% | min. 49 |
| Euro 2 | 1 Jan. 1996 | max. 0.050% | min. 49 |
| Euro 3 | 1 Jan. 2001 | max. 0.035% | min. 51 |
| Euro 4 | 1 Jan. 2006 | max. 0.005% | min. 51 |
| Euro 5 | 1 Jan. 2009 | max. 0.001% | min. 51 |
| Euro 6 | 1 Jan. 2014 | | |

Under Euro 6 the EN 590 now mandates no sulphur content in diesel fuels. Diesel powered light passenger and light commercial vehicle manufactured to meet the Euro 6 emissions standards will typically have been engineered on the assumption that the diesel fuel put in them will have no sulphur content.

The current standard for automotive diesel in Australia is Australian Standard for Automotive Diesel AS 3570. This mandates no more than 10 ppm sulphur, which is commensurate to Euro 5 of EN 590 of 1 Jan. 2009. Around 60% of diesel vehicles currently imported into Australia have a Euro 6 common rail diesel system. These vehicles may not be engineered to address the sulphur content of Australian diesel fuel.

It is generally recognised that the elevated sulphur content in available fuels in Australia has led to a tendency for these Euro 6 systems to clog and/or foul leading to reduced engine performance and, if unchecked, ultimate failure of the fuel system. The problem of clogging/fouling is particularly prevalent in the air intake system connected to the exhaust gas recirculation valve (or EGR valve).

Exhaust gas recirculation (EGR) is a nitrogen oxide (NOx) emissions reduction technique used in internal combustion petrol/gasoline and diesel engines. The EGR valve works by recirculating a portion of an engine's exhaust gas back to the engine cylinders. This dilutes the oxygen in the incoming air stream and provides gases inert to combustion to act as absorbents of combustion heat to reduce peak in-cylinder temperatures. It is generally recognized that NOx is produced in a narrow band of high cylinder temperatures and pressures. The EGR valve seeks to reduce the times the engine is operating under those conditions.

A side effect of lower peak in-cylinder temperatures is increased particulate matter (mainly carbon) that is not burned in the power stroke. Stricter regulations on particulate matter (PM) call for further emission controls to be introduced to compensate for the PM emissions increase caused by EGR. The most common is a diesel particulate filter (DPF) in the exhaust system which cleans the exhaust but causes a minor reduction in fuel efficiency due to the back pressure created. The nitrogen dioxide component of NOx emissions is the primary oxidizer of the soot caught in the DPF at normal operating temperatures. This process is known as passive regeneration. Increasing EGR valve rates causes passive regeneration to be less effective at managing the PM loading in the DPF. This necessitates periodic active regeneration of the DPF by burning diesel fuel in the oxidation catalyst in order to significantly increase exhaust gas temperatures through the DPF to the point where PM is quickly burned by the residual oxygen in the exhaust.

By feeding the lower oxygen exhaust gas into the intake, diesel EGR systems lower combustion temperature, reducing emissions of NOx. This makes combustion less efficient, compromising economy and power. The normally “dry” intake system of a diesel engine is now subject to fouling from soot, unburned fuel and oil in the EGR bleed, which has little effect on airflow. However, when combined with oil vapor from a Positive Crankcase Ventilation Valve (PCV) system, this can cause buildup of sticky tar in the intake manifold and valves. It can also cause problems with components such as swirl flaps, where fitted. Diesel EGR also increases soot production. EGR systems can also add abrasive contaminants and increase engine oil acidity, which in turn can reduce engine longevity.

Regular cleaning of the air intake system of engines which employ an EGR valve is therefore desirable. It is especially desirable for common rail diesel engines. A number of products are commercially available for that purpose. Some examples are BG Fuel Injection System Cleaner manufactured by BG Products, Inc of 740 S Wichita St, Wichita, Kans. 67213, USA; Wynns EGR4 Exhaust Gas Recirculation Cleaner, manufactured by ITW AAmtech of Sydney, Australia; and JLM Diesel Air Intake & EGR Cleaner, manufactured by JLM Lubricants B.V., Schiphol Boulevard 127, 1118 BG, Schiphol, Nederland.

Commonly such products are available in liquid or aerosol form and are delivered to the air intake system manually or via specialised equipment.

An example of such specialised equipment is provided by BG Products, Inc of 740 S Wichita St, Wichita, Kans. 67213, USA and is sold under the brand name BG Diesel Induction System. It comprises a reservoir for holding a volume of cleaning fluid which is pneumatically pressurized. The reservoir feeds an atomizing jet unit via a timing unit. Conduits link the reservoir to the timer and the timer to the atomizing jet. The timing unit is remote from the atomizing jet and is suspended from the bonnet or hood of the vehicle. The cleaning fluid is delivered from the atomizing jet though a manifold directly connected at the throttle body of the vehicle. The timing unit electronically meters out the product at 12 or 17 second intervals at 1500 rpm over a 45-60-minute cleaning cycle.

It is a known problem of delivery of cleaning solutions into the air intake system of a Common Rail Diesel (CRD) system that the product will not consistently atomize. This is an issue whether the solution is distributed in pressurized spray cans (as in the Wynns and JLM products above) or pressurized using specialized equipment (such as that supplied by BG Products, Inc described above). In the case of delivery at an extended distance from the throttle body or the EGR valve, poor or inconsistent atomization may cause the cleaning solution to condense and/or pool in the pipe work.

Reconnection of the air intake system following the cleaning process will increase the vacuum in the air intake system, drawing the liquefied cleaning product into the engine. Since the cleaning solutions generally comprise flammable materials, this causes the engine revs to increase dramatically and overrun even after the source of ignition has been turned off. Should there be soot, unburned fuel and oil in the EGR valve bleed as described above, these materials may also combust. Alternatively, or additionally, the engine may have been subject to some degree of mechanical degradation causing elevated levels of oil in the PCV and intercooler (if the motor is a turbo-diesel motor). The PCV is a variable orifice that controls the flow of crankcase fumes, admixed with fresh air admitted to the crankcase by a breather, into the intake tract. This oil may in turn be drawn through the intake circuit providing another source of uncontrolled combustion. Uncontrolled overrun can, and sometimes does, result in the eventual destruction of the motor.

For this reason, it is common to connect the cleaning solution source directly to the throttle body rather than to the air box to minimise the prospect of condensing and pooling of the cleaning solution. Most manufacturers specifically warn against application of their solutions directly into the intercooler or turbo charger of the engine. A disadvantage of this is that components upstream of the throttle body (such as the turbo and intercooler) remain uncleaned.

In order to limit the likelihood of pooling, some manufacturers have utilised pulse cycling of the delivery of cleaning solutions into the intake system. By controlling the amount of fluid in each pulse and the frequency of pulses the likelihood of condensing and pooling is reduced and sometimes eliminated. However, such systems are slow, with the average cleaning cycle taking 45 to 60 minutes to complete. These systems must also be connected directly to the throttle body as described above—meaning that components up stream of the throttle body (such as the turbo and intercooler of a diesel turbo motor) are not cleaned.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in Australia or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

### SUMMARY

According to one aspect of the present invention there is provided an automotive induction system cleaning module comprising of a connector configured to connect in use to a supply of cleaning solution, an injector in fluid communication with the connector, and a nozzle in fluid communication with the injector, wherein the injector and nozzle are closely connected so as to minimise a fluid flow path between them.

Preferably the connection between the injector and the nozzle is a direct connection.

Preferably the module further comprises a timer adapted to control the opening and closing of the injector.

Preferably the module further comprises a timer adapted to control a first duty cycle of the injector.

Preferably the first duty cycle opens the injector for time periods greater than or equal to 0.3 seconds and closes the injector for time periods greater than or equal to 0.3 seconds.

Still more preferably the unit further comprises a second timer adapted to control the injector according to a second duty cycle.

Preferably each of the plurality of duty cycles is selectable via a switch, button or manual input. Alternatively, each of the plurality of duty cycles is selectable via a computer interface.

Preferably the injector is a Bosch 200 cc Inj 006-06 injector.

Preferably the nozzle is a Monarch 1.0 Gal 60 Degree Type R nozzle capable of delivering 1 gallon of cleaning solution per minute under continuous load

Preferably the connector (2) is a Rectus 21 connector.

According to a second aspect of the present invention, there is provided a method of operating an automotive induction system cleaning module wherein the module comprises a connector configured to connect in use to a supply of cleaning solution, an injector in fluid communication with the connector, and a nozzle in close fluid communication with the injector, the method comprising the steps of:
a. Connecting the module to an induction system of a vehicle;
b. Connecting the module to a source of cleaning fluid;
c. Connecting the module to a power supply;
d. Pressurizing the cleaning fluid to be provided to the injector of the module; and
e. Operating the module so that atomized cleaning fluid is introduced into the induction system of the vehicle via the module.

Preferably the connection between the nozzle and the injector is a direct connection.

Preferably the unit is connected downstream of the airbox. Still more preferably the unit is connected immediately adjacent the airbox so as to facilitate cleaning of components of the induction system such as the turbo charger, intercooler and associated pipework in a turbo motor.

Preferably the cleaning solution is introduced into the induction system via a first duty cycle of the injector.

Preferably the first duty cycle is greater than or equal to 0.3 seconds open followed by greater than or equal to 0.3 seconds closed.

Still more preferably the first duty cycle is four seconds with the injector open followed by four seconds with the injector closed.

Alternatively, or additionally, the cleaning solution is introduced into the induction system via a second duty cycle of the injector. Preferably the second duty cycle is six seconds with the injector open followed by four seconds with the injector closed;

Preferably the power supply is the 12 v battery of the vehicle.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings, in which:

FIG. 1 is a cross-sectional view of a preferred embodiment of the injector module and components.

FIG. 1A is a magnified view of the area marked A in FIG. 1.

FIG. 2 is an exploded view of the injector module of FIG. 1.

FIG. 3 is a schematic view showing the method of use of the injector module of FIGS. 1 and 2.

FIGS. 4 and 5 are detailed views of the module enclosure and switch cover of the injector module of FIGS. 1 and 2.

FIG. 6 is a schematic view of a preferred embodiment of an adaptor manifold for use with the present invention; and

FIG. 7 is a circuit diagram of the electrical components of the injector module depicted in FIGS. 1-5.

### DETAILED DESCRIPTION

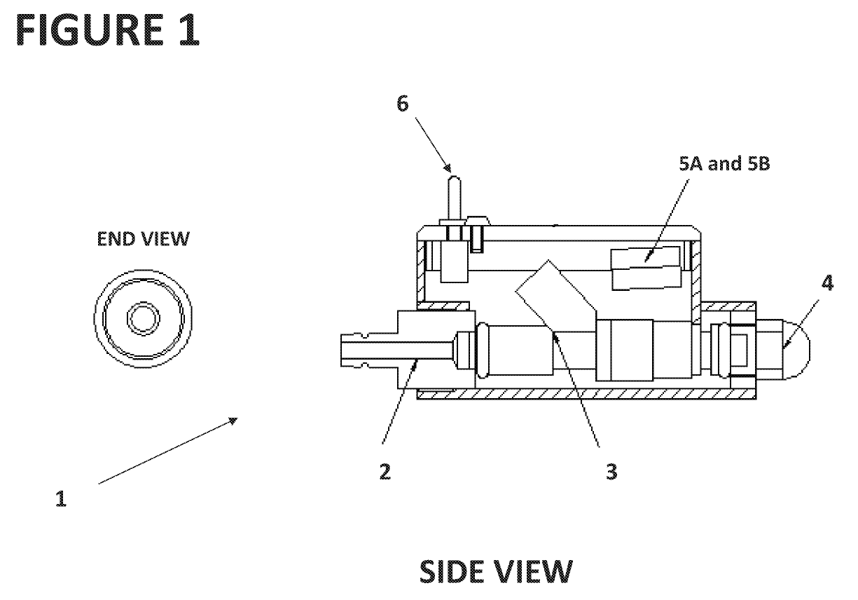

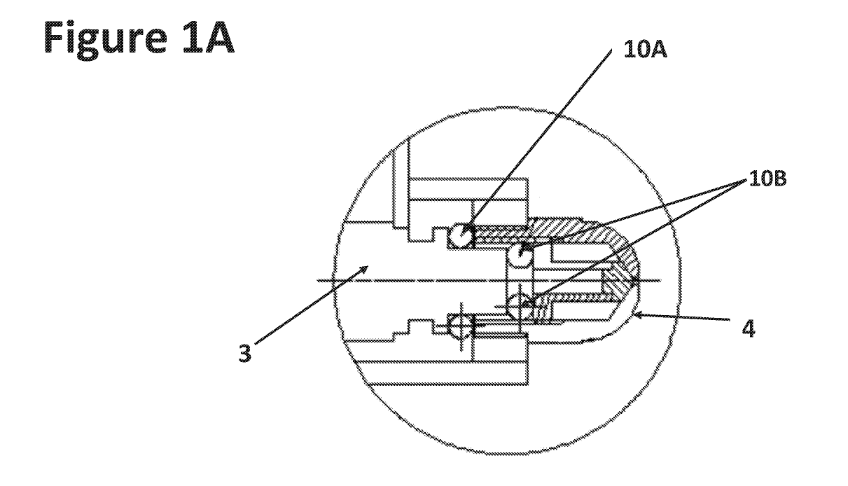

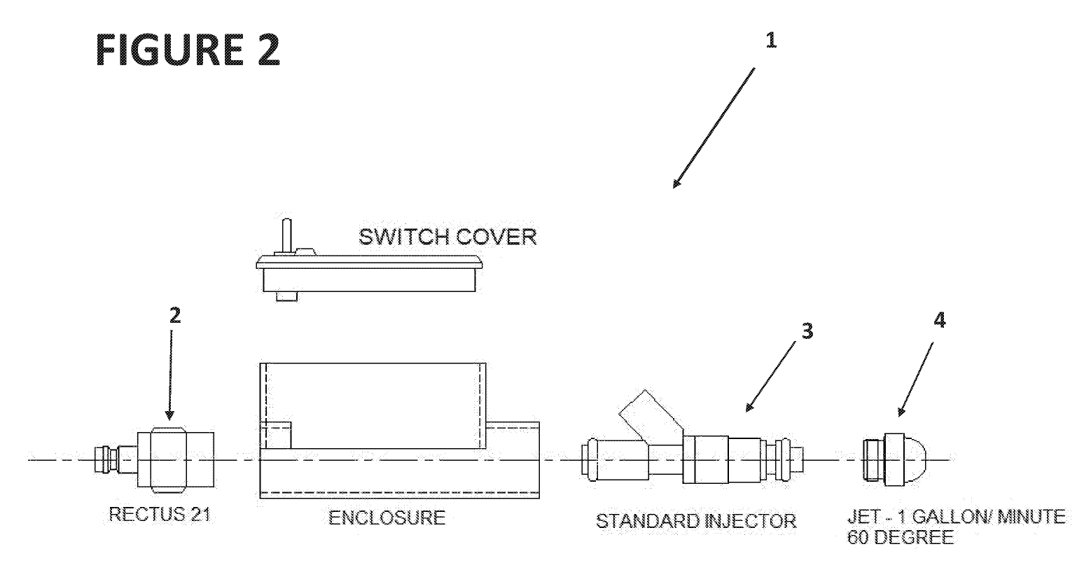

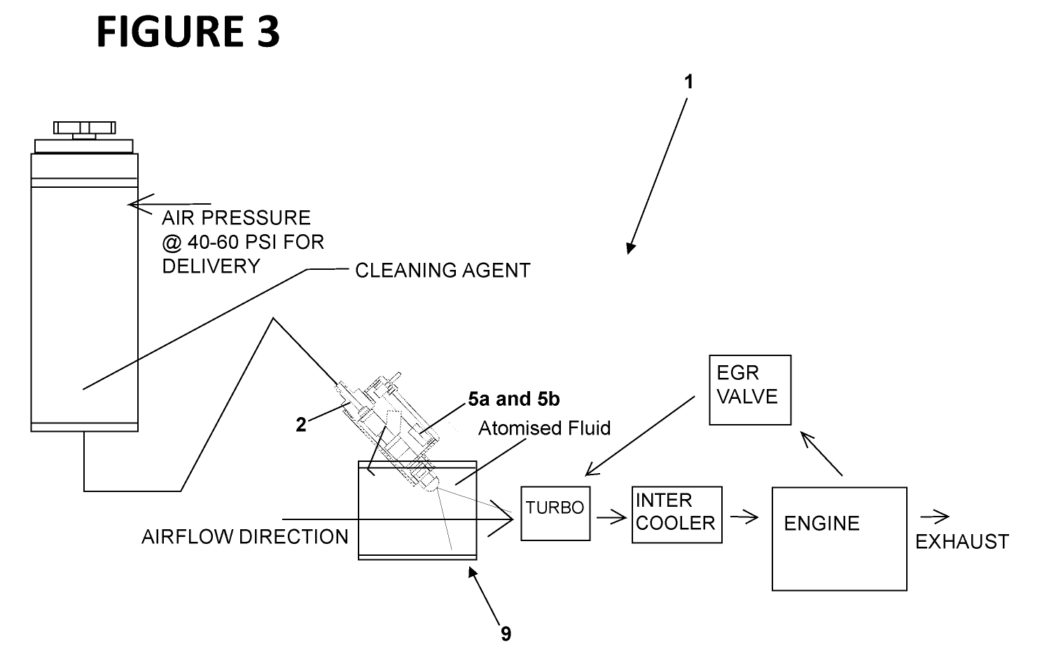

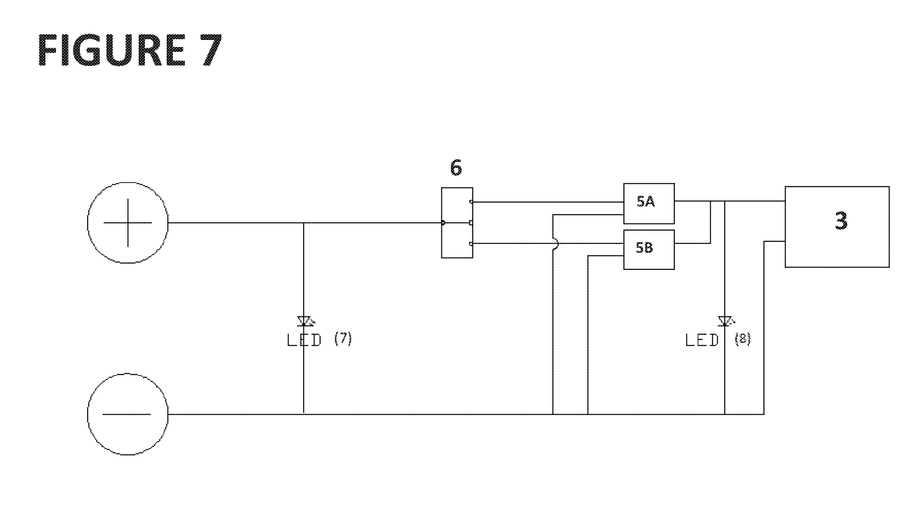

FIGS. 1 and 2 show a cross-sectional and exploded view of an injector module (generally indicated as (1)) and its components according to one embodiment of the invention. As can be seen from those Figures the injector module comprises a connector (2) connected to a source of cleaning solution (best seen in FIG. 3). The connector (2) is in fluid communication with an injector unit (3) which in turn is in fluid communication with a nozzle (4). First and second timers (5a and 5b) control the opening and closing of the injector (3) to limit the amount and frequency of cleaning solution delivered via the injector (3) to the nozzle (4) and into the induction system of the vehicle as discussed below. The module is connected to a source of power, for example, via positive and negative connection leads (not shown in FIGS. 1 and 2 but seen in FIG. 7) although any suitable means of powering the unit may be used.

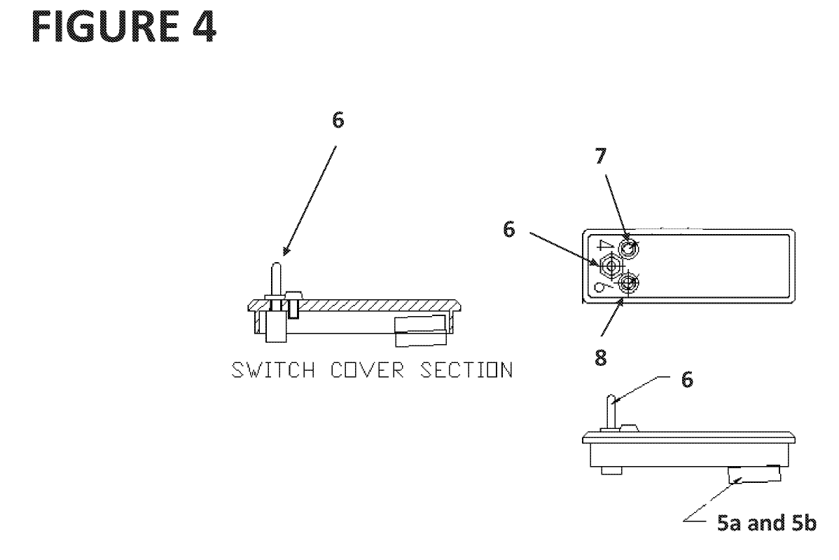

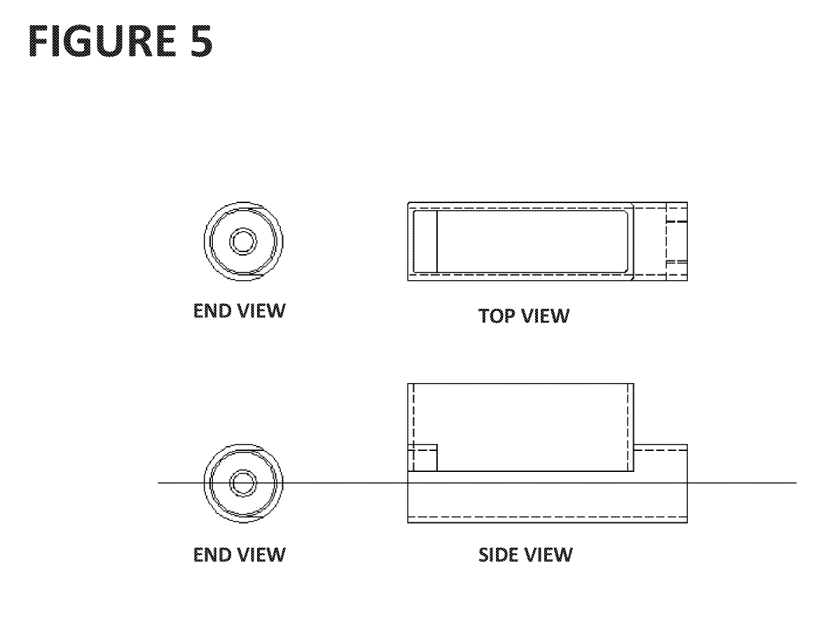

The operation of each timer (5a and 5b) is controlled by a manual control, for example a three-position switch (6) best seen in FIGS. 4 and 7. The switch (6) has associated first and second LED lights (7) and (8). When the unit (1) is connected to a power source the first LED (7) lights up to indicate that the unit has power. The second LED (8) indicates the mode of operation of the timers (5a and 5b) as discussed below. Timers (5a and 5b), switch (6) and LED lights (7) and (8) are each connected to a power supply (not shown) and are wired according to the circuit diagram depicted in FIG. 7. In preferred embodiments the power supply is the 12 v battery of the vehicle being serviced. Preferably the componentry of the unit is housed in a compact metal enclosure, a preferred configuration of which is shown in FIG. 5.

In use the connector (2) of the module (1) is fluidly connected to a pressurized source of liquid cleaning solution as shown in FIG. 3. The cleaning solution may be pressurised by any suitable means. For example, a source of pressurised air from an air compressor may be supplied to the reservoir. Alternatively, pressure may be generated through a pump located between the reservoir and the module or within the module itself. Other means will be known to those skilled the art. The inventor has found that particularly effective results are achieved using a Wynns Enviropurge Plus reservoir which is elevated with respect to the injector module (1) and also pressurised to 40-60 p.s.i using a standard workshop air compressor in known fashion.

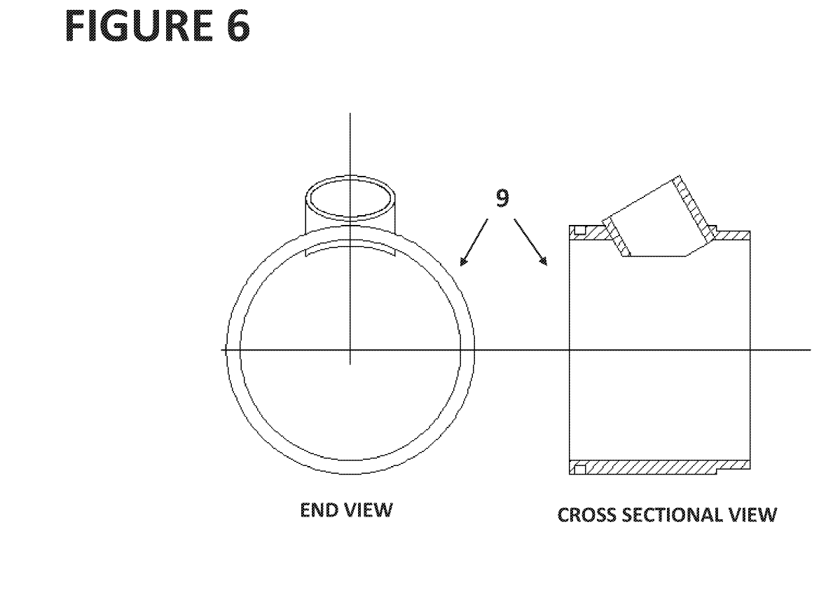

The module (1) is in turn connected between the airbox and the induction system of the vehicle being serviced (not shown). FIGS. 3 and 6 depict an adapter manifold (9) for this purpose but other suitable connection means will be apparent to those skilled in the art and will vary depending on the make and model of the vehicle to which the module (1) is to be attached. It is important that the connection into the induction system is reasonably air tight (so that cleaning solution does not blow back past the module (1) in operation (effectively utilizing vacuum generated within the induction circuit) and is not disposed at an angle which would result in cleaning solution being excessively sprayed directly on to the surfaces of the adapter manifold (9) and/or induction system adjacent the module (1) and cause condensing of the cleaning fluid and possible pooling. The inventor has found that particularly effective results can be achieved by disposing the module (1) at an angle of around 50-60 degrees, for example 45 degrees, to the air flow into the induction system as shown by the arrow marked “airflow direction” in FIG. 3.

The module (1) is configured with three modes of use via the three-position switch (6):
Switch position centered: injector (3) is closed and cleaning fluid may not pass through the injector. Second LED (8) is not illuminated;
Switch position left: timer (5a) is activated to open and close injector (3) at a first duty cycle. Second LED (8) is illuminated to indicate the module (1) is on and the first duty cycle is activated; and
Switch position right: timer (5b) is activated to open and close injector (3) at a second duty cycle. Second LED (8) is illuminated to indicate the module (1) is on and the second duty cycle is activated.

Operation of the module is performed as follows:
1. Connect the module (1) on the down-stream side of the air box via manifold (9). The inventor has found that connection of the module upstream of the airbox may leave a film of cleaning solution on the air flow sensor and should be avoided;
2. Connect the module (1) to a source of cleaning solution and pressurise that source;
3. Connect the module (1) to a power source (preferably the battery of the vehicle being serviced). First LED (7) will illuminate to indicate the module (1) has been correctly connected and is ready for operation. Cleaning agent will be in a position to feed by pressure to the module (1) once the injector unit (3) opens as described below;
4. Start the engine of the vehicle. Note that in vehicles with an air flow sensor (primarily petrol engines) it may be necessary to reconnect the airbox to the manifold (9) to prevent a low flow/error signal being generated by the air flow meter in the air box which signal will cause the motor to shut down. Preferably the vehicle is operated at 2500-3000 rpm for this stage of the cleaning process. The inventor has found 2500-3000 rpm to be a particularly effective range for ensuring circulation of the atomized cleaning solution via the air intake system. Revolutions above 2500 rpm will also engage the turbo charger of most Euro 6 diesel motors ensuring thorough cleaning of that component and the associated intercooler;
5. Toggle the switch to the left position. Timer (5a) will activate injector (3) to open and close according to a first duty cycle. Second LED (8) will also illuminate to indicate the module (1) is actively cleaning the system. When injector (3) is open, pressurised cleaning fluid will pass through the injector to atomising nozzle (4). The atomised fluid will in turn enter into the manifold (9). Since the vehicle's engine is running, air is being drawn through the manifold and enters the engine via the vehicle's induction system. The atomised cleaning fluid mixes with this air and is also drawn into the engine via the induction system to clean the induction system of the vehicle. Cleaning fluid will also clean the EGR valve as the atomised fluid/gas is recirculated as shown in FIG. 3;
6. Alternatively, the three-position switch (6) can be switched to the right position (as discussed below). Second LED (8) will illuminate and timer (5b) will activate injector (3) to open and close according to a second and different duty cycle; and
7. The cleaning process ends when the source of cleaning fluid is expended or the operator determines the cleaning process should be terminated in known fashion. At this point the switch (6) is switched to the centered position (to disable to injector (3) of the module (1)) and the engine is stopped. The module (1) can be disconnected from the vehicle's battery, and the module (1) and manifold (9) can be removed from the vehicle and the air box reconnected.

The operator will be able to determine when the cleaning process should be terminated based on the smoke being exhausted by the vehicle or alternately if the rpm is climbing excessively. Heat from the exhaust will increase with each burst of cleaning solution indicating combustion of the cleaner. The by-product (smoke) can be seen by the operator and smelt. As contaminants are removed from the engine these levels of smoke will increase. The operator can determine when to end the cleaning cycle when the levels of smoke reduce or dissipate. Additionally, an increase in rpm indicates the cleaning agent is clearing excessive carbon from the system. If the rpm climbs excessively this may indicate that all contaminants are being combusted and engine rpm should be adjusted accordingly until rpm stabilizes and the cleaning agent is exhausted.

The inventor has surprisingly found that the unit facilitates cleaning of all components of the induction system without pooling of the cleaning solution and the adverse consequences discussed in the background section of this specification. These components include components such as the turbo charger and intercooler which have traditionally proven difficult to clean without pooling. Intercoolers typically comprise a complex arrangement of conduits designed to cool fluids (including gasses) via heat exchange. The possibility of gas containing atomised cleaning solution being trapped in the intercooler and subsequently condensing and pooling in this component is high.

The inventor believes that the improved performance of the unit is attributable to three factors:
The positioning of the injector (3) relative to the atomizing nozzle (4);
The selection and elevated “on time” of the injector (3); and
The pulse timing (or pulsatile flow (ie quantity and rate) of the cleaning fluid delivery via a duty cycle.

The injector (3) is placed in fluid communication with the nozzle (4) as close as possible within the module (1). This close relational arrangement is best seen in FIG. 1A. As can be seen in this Figure, nozzle (4) encapsulates the downstream end of injector (3) in a nested arrangement. The connection between these components is sealed by a first O-ring seal (10a) between the base of the nozzle (4) body and a radial shoulder formed on the injector (3) body, and a second O-ring seal (10b) between the front face of the injector (3) and a radial shoulder formed inside the nozzle (4) body. In this way the connection between the injector (3) and the nozzle (4) is a direct mechanical connection (ie there is no intermediate conduit or component to extend the flow path). This eliminates dead space between the injector (3) and nozzle (4) and so minimises the possibility of fluid pooling or dripping after the injector (3) has closed. This arrangement also minimises head space to the aperture of the nozzle (4) which results in no discernable back pressure in the system.

Additionally, the injector (3) provides an efficient means of controlling the amount of fluid supplied to the nozzle (4) and facilitates rapid transitions between a state when atomized fluid is being delivered from the nozzle (4) and a state where it is not. It is believed that prior art devices suffer from pooling in the supply conduit between the valve/delivery/metering device and nozzle and also suffer from successive drips of cleaning fluid forming on the tip of the injector which are subsequently introduced into the induction system thereby increasing the likelihood of pooling and consequent damage. These issues have necessitated continuous delivery or pulsed delivery directly to the throttle body in competitor products/systems such as those described above with inferior results.

Pooling is primarily caused by excess delivery (insufficient rpm and or flooding the motor with product) and exacerbated by burst atomization with excessive dripping of product.

The inventor has found that particularly effective results are achieved utilising a Bosch 200 cc Inj 006-06 injector manufactured by Robert Bosch GmbH. Although this is a standard manifold injector it is believed that the metering in volume per second of the injector is negated by the elevated on time pulse timing providing unexpected and improved atomization by the nozzle.

All fuel injectors are operated according to a duty cycle. The fuel injector duty cycle (IDC) is the percentage of time the injector is supplied with power. The time during which the injector is powered (or activated) is called the injector pulse width (IPW). During normal engine operation, a fuel injector fires once during the four strokes of the Otto cycle, which last for two revolutions of the engine. The Otto Cycle is a thermodynamic cycle that describes the functioning of a typical spark ignition piston engine.] It is the thermodynamic cycle most commonly found in automobile engines.

Since the Otto cycle is measured in milliseconds, fuel injectors are configured and operated with opening and closing times of millseconds. As an example, at 3000 rpm it takes 0.040 seconds or 40 milliseconds (ms) for the engine to complete two revolutions (3000 rpm divided by 60 equals 50 revs per second; invert to get 0.02 sec per rev or 0.04 second for two revs).

Since it is undesirable for the injector to be constantly delivering fuel during the entire Otto Cycle this means that the injector will be configured to open for less than 40 ms. These opening times reduce as engine speed increases. At 6000 rpm, the Otto cycle takes 20 ms for two revolutions.

The duty cycle of the present invention opens and closes the injector for much greater time periods than is conventional.

The inventor has found that particularly effective results can be achieved on a variety of engine displacements by varying the length of time that the injector remains open in an open/closed duty cycle. In practice the following duty cycles have proven to be particularly effective:
First duty cycle: four seconds open, four seconds closed. This duty cycle is suitable for diesel engines up to 2000 cc capacity; and
Second duty cycle: six seconds open, four seconds closed. This duty cycle is suitable for diesel engines over 2000 cc in capacity.

The elevated “on time” for the second duty cycle permits more cleaning solution to be delivered to a larger capacity engine. The four second “off time” has been found by the inventor to be a particularly effective time frame to permit engines of any capacity to thoroughly combust/deliver the cleaning solution through the intake system and to the engine components.

It will be appreciated however that other duty cycles may be advantageous. For example, a large displacement diesel engine (ie over 2000 cc in capacity) with a high level of contamination will elevate in RPM quite rapidly as the cleaning agent removes contaminants from the induction system. In this case the open time of the injector may be reduced to lessen the effect/amount of cleaning product delivery and reduce engine RPM in an alternative duty cycle. Once the RPM has settled the original duty cycle may be resumed.

Preliminary tests conducted by the inventor suggest that the minimum duty cycle for effective operation of the module is 0.3 second open, 0.3 second closed. It has been found that opening the injector for less than 0.3 second results in significant dripping when the injector is subsequently closed. The nozzle requires sufficient fluid to atomize effectively and it is thought that delivery over time frames of less than 0.3 second will deliver insufficient cleaning fluid for the nozzle to work effectively—causing the dripping observed by the inventor. It is also impractical to pulse fluid into the engine at intervals of less than 0.3 second without shortening the time the injector is closed commensurately—which would essentially mimic the continuous application described in the background to this specification.

Similarly, it has been found that 0.3 second is the minimum time frame to allow the cleaning fluid to dissipate following delivery to the engine.

The inventor has found that a vehicle can be safely and effectively cleaned using the apparatus described above through a process which lasts around 10-15 minutes. This compares extremely favourably to competitor systems the most efficient of which (that manufactured by BG Products, Inc) takes around 60 minutes, while at the same time delivering a superior result by cleaning the entire induction system including the turbo charger and intercooler and interconnecting pipework. The consequent cost savings to those in the automotive industry in terms of time and labour will be readily apparent to those in the art.

### Variations

While selection of the duty cycles has been described by reference to a mechanical switch, those skilled in the art will appreciate that other means enabling a user or machine to select between modes may be employed. For example, separate buttons may be provided or the duty cycles may be selected via a graphical user interface, for example in the form of a touch screen or the like operatively connected to the timers (5a and 5b) and other circuitry of the unit (1). Alternatively, the selection of duty cycles may be selected by a processor based on certain input conditions.

Similarly, while the inventor currently believes that two duty cycles as described above provide the best results for engines of differing capacities, different or additional duty cycles may be provided (including a single duty cycle) without departing from the scope of the invention.

While in preferred embodiments, separate duty cycles are provided by separate timers (5a and 5b) those in the art will appreciate that a single duty cycle may require only one timer and/or it is within the scope of the invention to provide multiple duty cycles via alternative means known in the art (for example by a single variable timer and/or via a PLC or other computer programmable hardware).

While the inventor has obtained favourable results using the Bosch Inj 006-06 injector as aforesaid, those in the art will appreciate that other injectors by the same or alternative manufacturers with commensurate characteristics may be employed without departing from the scope of the invention.

In preferred embodiments, nozzle (4) is a Monarch 1.0 Gal 60 Degree Type R nozzle delivering 1 gallon of cleaning solution per minute. However, those in the art will appreciate that other nozzles may be employed without departing from the scope of the invention provided they are sufficient to deliver atomized cleaning solution to the induction system.

In preferred embodiments the connector (2) will be a Rectus 21 connection. However, those skilled in the art will appreciate that other makes and types of connectors might be used without departing from the scope of the invention.

In preferred embodiments, the power supply is the 12 v battery of the vehicle being serviced. However, the unit may also be provided with its own or alternative power supplies.

Finally, as stated above, the cleaning solution may be pressurised by any suitable means. In preferred embodiments a source of pressurised air from an air compressor will be supplied to the reservoir. Alternatively, pressure may be generated through a pump located between the reservoir and the module or within the module itself. Other means will be known to those skilled the art.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

Aspects of the present invention have been described by way of example only and it should be appreciated that modifications and additions may be made thereto without departing from the scope thereof as defined in the appended claims.

1. An automotive induction system cleaning module comprising:
a connector configured to connect in use to a supply of cleaning solution;
an injector in fluid communication with the connector; and
a nozzle in fluid communication with the injector,
wherein the injector and nozzle are closely connected so as to minimise a fluid flow path between them.

2. The module of claim 1 wherein the connection between the injector and the nozzle is a direct connection.

3. The module of claim 1 further comprising a timer configured for controlling the opening and closing of the injector.

4. The module of claim 1 wherein the timer is configured for opening and closing the injector according to a first duty cycle.

5. The module of claim 1 wherein the duty cycle opens the injector for time periods greater than or equal to 0.3 seconds and closes the injector for time periods greater than or equal to 0.3 seconds.

6. The module of claim 1 further comprising a second timer configured for controlling the injector according to a second duty cycle.

7. A method of operating the automotive induction system cleaning module of claim 1, the method comprising the steps of:
a. Connecting the module to an induction system of a vehicle;
b. Connecting the module to a source of cleaning fluid;
c. Connecting the module to a power supply;
d. Pressurizing the cleaning fluid to be provided to the injector of the module; and
e. Operating the module so that atomized cleaning fluid is introduced into the induction system of the vehicle via the module.

8. The method of claim 7 wherein the module is connected downstream of an airbox of the vehicle.

9. The method of claim 7 wherein the module is connected immediately adjacent the airbox.

10. The method of claim 7 wherein the cleaning fluid is introduced into the induction system according to a first duty cycle of the injector.

11. The method of claim 7 where the first duty cycle of the injector is greater than or equal to 0.3 seconds open followed by greater than or equal to 0.3 seconds closed.

12. The method of claim 7 wherein the first duty cycle is four seconds open followed by four seconds closed.

13. The method of claim 7 wherein the cleaning fluid is introduced into the induction system according to a second duty cycle of the injector.

14. The method of claim 7 wherein the second duty cycle is six seconds open followed by four seconds closed.

15. The method of claim 7 wherein the power supply is the 12 v battery of the vehicle.
